(19) United States
(12) Patent Application Publication
(10) Pub. No.: US 2026/0000037 A1
(43) Pub. Date: Jan. 1, 2026

(54) FLEXIBLE HYDROPONIC GARDEN

(71) Applicant: John Correia, Iowa City, IA (US)

(72) Inventor: John Correia, Iowa City, IA (US)

(21) Appl. No.: 19/079,673

(22) Filed: Mar. 14, 2025

Related U.S. Application Data
(62) Division of application No. 19/078,058, filed on Mar. 12, 2025.
(60) Provisional application No. 63/666,043, filed on Jun. 28, 2024.
(60) Provisional application No. 63/706,537, filed on Oct. 11, 2024.

(51) Int. Cl. A01G 31/02

(52) U.S. Cl. CPC A01G 31/02

(57) ABSTRACT

Methods, devices, and a system for growing and germinating seeds, clones, rootstock, and mature plants use a unique yet efficient elastic force-based method in high-production hydroponics. The application of this elastic force-based holding technique results in several advantages: improved root health through the elimination of root strangulation and binding, simplified plant removal for environmental friendliness, enhanced hydroponic gardening efficiency and versatility, minimized shipping weight, compatibility with standard industry gardens, and reduction of root-bound growth and associated issues. In one example, a unique method of using a thin film to create a flexible hydroponic garden that is equipped with an optional elastic method to retain vegetative plants.

### CROSS REFERENCE TO RELATED APPLICATIONS

This is a divisional patent application which claims priority under 35 U.S.C. § 120 to U.S. Ser. No. 19/078,058, filed Mar. 12, 2025, which is hereby incorporated by reference in its entirety, including without limitation, the specification, claims, and abstract, as well as any figures, tables, appendices, or drawings thereof.

This application claims also claims priority under 35 U.S.C. § 119 to provisional patent application U.S. Ser. No. 63/666,043, filed Jun. 28, 2024, and to provisional patent application U.S. Ser. No. 63/706,537, filed Oct. 11, 2024. The provisional patent applications are hereby incorporated by reference in its entireties herein, including without limitation: the specification, claims, and abstract, as well as any figures, tables, appendices, or drawings thereof.

### TECHNICAL FIELD

The present disclosure relates to horticulture specifically to the growth of plants by soil-less cultivation, e.g. hydroponics, and provides special methods and systems therefore.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Hydroponics expedite plant growth and enhance crop nutrition by using nutrient-rich solution rather than soil. A hydroponic system consists of a controlled growing environment where plants are directly fed with nutrient solutions via various methods. These techniques allow for customization of the plant's environment and can result in complex or simple setups.

Hydroponic systems have become increasingly popular as an alternative method for plant cultivation, offering improved control over growing conditions and increased crop yields. Currently, hydroponic gardens are typically constructed using rigid and expansive materials such as glass or acrylic containers, which can be large and bulky, requiring significant space and resources to set up.

These traditional systems often rely on fixed, unyielding structures that limit their adaptability and scalability. The existing solutions also frequently involve complex plumbing and irrigation systems, which can make them cumbersome and difficult to maintain. The current state of hydroponic technology is characterized by a lack of flexibility and portability. Existing systems are typically large, heavy, and require significant setup and maintenance, making it challenging for users to easily setup, relocate or reconfigure their gardens as needed.

Traditional hydroponic systems include components beyond the rooting chambers like artificial lighting, meters, sensors, switches, removable vessels, platforms for holding vegetation, or even internet connectivity. All components chosen by the designer to create the intended growing environment are part of a hydroponic system.

For example, hydroponic systems, such as the one described in U.S. Pat. No. 6,247,268, generally consist of sealed tubing that defines a container for conveying liquids, including at least a portion with multiple openings. These systems can be configured in various forms: from simple configurations with a singular grow spot hole to more complex ones incorporating multiple grow spots for holding plant vessels.

Hydroponic gardens exist in various forms and use multiple methods to deliver nutrient solutions to roots. A functioning hydroponic method is essential for growing plants within a hydroponic system. Numerous combinations of methods and techniques can be employed within a single system for optimal crop growth. Combining two efficient hydroponic methods within a single system can maximize crop yields, while also offering flexibility for emergency situations.

The philosophy of the hydroponic gardens design should be to create the hydroponic garden around the type of vegetation grown, rather than forcing the growing vegetation to adapt to non-beneficial growing conditions. This principle is crucial for a successful hydroponic crop based on its specific needs.

This reference's main focus is on the various devices that secure vegetation and root bodies within hydroponic gardens. This reference encompasses unique methods for holding vegetation in a garden. Most gardens employ modular vessels for this purpose. The novelty of this art lies in hydroponic gardens featuring root chambers or nutrient reservoirs situated directly below the vessel, supporting the root bodies.

Beyond offering a stable platform, these vessels function as a modular apparatus within the hydroponic system. They enable users to transplant and relocate crops as needed without damaging or stressing the vegetation within by selecting alternative gardens.

In hydroponic gardening, two primary methods exist for holding vegetation and seeded medium substrate. The first method Uses gravity to retain sown vegetation within a container—this method encompasses various types of rigid vessels like modular vessels filled with inert media or net pots. The second method secures the plant by encircling its main stem with a flexible cuff.

Modern hydroponic gardening primarily relies on cylindrical or squared-shaped baskets, also known as “basket-shaped apparatuses.” These versatile containers, which include Net-pots and Grow pots (as illustrated in U.S. Pre-grant Pub. No. 2015/0319946 A1, FIGS. 1-5), stand out from traditional gardening pots due to their multiple apertures on the rigid sides and bottoms.

Unlike traditional soil gardening containers, these types of hydroponic containers boast improved drainage properties. This feature enables hydroponic nutrients to flow effortlessly through the vessel, while in certain cases permitting select root systems to extend beyond the container's rigid boundaries.

Plants grown in conventional vessels, as seen in previous art, are typically secured by a heavy substrate medium such as Hydroton clay pebbles, stones, glass beads, or unlined rocks. The primary function of this inert medium is not to retain moisture but rather to anchor the roots through gravity. Plants remain stable solely due to their rooted attachment and gravity's influence.

Basket-shaped hydroponic apparatuses, a common choice in previous art, have garnered considerable success but carry an inherent disadvantage: their rigidity can lead to damage as expansive root systems try to maneuver through constricting root apertures. This limitation may result in root-bound conditions that hinder growth, decrease longevity, and reduce profitability, especially in high-production settings.

Additionally, basket-shaped pots poses challenges: firstly, their dependence on heavy substrate mediums for vegetation retention makes shipping burdensome due to weight and instability, and unsuitable for zero gravity conditions. Secondly, monochromatic colors (commonly black or white plastic) can make it difficult to discern small root pieces from the hydroponic system when separating them. Another problem is that the rigidity of these pots may discourage users from carefully removing plants before transferring them to soil, potentially leading to root strangulation and binding within the vessel.

I'd also like to recognize another apparatus not conventionally regarded as a hydroponic nursery pot or vessel but frequently employed with hydroponic systems: the foam collar. Shaped like a squishy circular foam puck, typically made of neoprene or another malleable foam (U.S. Pat. No. 10,517,241B1), this apparatus functions to secure the vegetation around its main stem and position it into the root chamber.

Distinct from “basket-shaped” apparatuses, foam puck-shaped collars employ a pinching method created by a single cut line extending from their center to the edge. This slit enables interaction with the root chamber while providing an insertion point for a single living plant stem. To incorporate this foam collar into a garden setup, it is wedged into the grow spot hole using its outer circumference.

Foam puck-shaped hydroponic apparatuses do not retain substrate for roots, leaving them naked within the root chamber. During electrical outages, exposed roots are susceptible to dehydration in the absence of pumped nutrient solution. Without a moist medium, the planted vegetation may wilt and potentially die. The importance of implementing alternative water retention strategies when using foam puck-shaped apparatuses is underscored by this vulnerability.

The other limitations of hydroponic systems using foam pucks include their inability to accommodate larger plants due to insufficient rigidity, preventing secure placement within the system. Moreover, problems intensify for plants with multiple trunks or below-ground stalks, which often struggle to grow through the foam from below it due to inadequate method for growth below the apparatus to reach the surface where there is light. As a consequence, these challenges can reduce overall production efficiency and waste valuable resources.

Some hydroponic systems featuring gardens without grow spots utilize an open reservoir like the porous plate method, which constructs a screen or mesh cover over nutrient solution. These gardens, whether passive or powered, are limited in their ability to accommodate larger root systems due to the tight formation of the screens. Micro-greens and small-rooted plants thrive in these arrangements. However, industrialized versions can mechanically convey vegetation above the root chamber or incorporate a porous filter material for seed sowing (U.S. Pat. No. 4,382,348). These gardens lack separate modular platforms for easy transplanting and may strangle thickening roots growing through the small apertures in the rigid screens.

Some hydroponic gardens do not require a modular vessel for sowing vegetation; instead, plants can fit within the grow spot hole circumference. For example, deep water culture (DWC) raft systems utilize large trays or tanks filled with nutrient solutions where plants are suspended on floating rafts. Another type of hydroponic system is called flood and drain, which uses large beds filled with heavy substrate medium in which plants can be placed. These systems are among the hardest to clean and maintain. Plants grown in these systems are held into the garden either by gravity or by wedging or pinching them into place to prevent them from floating away.

Another type of hydroponic garden patent U.S. Pre-grant Pub. No. 2005/0241231A, the old hydroponic art depicted in FIG. 4 employed a capillary matting material (felt, mineral sponge, or cotton rope) for retaining plants near nutrient solutions and creating a tapered hourglass shape where the vegetation sits by gravity at the top and the rest of the capillary material is anchored to the bottom where it absorbs nutrients. However, this arrangement has challenges: it could be damaging to root systems due to its fibrous nature, and removal means you have to interact with the swampy nutrient solution for basic maintenance of the apparatus.

In all cases, the prior art uses mostly gravity or a pinching method around the stem to hold vegetation. It is clear to see that none of these previous apparatuses is designed to hold plants by elastic force alone.

Thus, there exists a need in the art for a method of using elastic force to retain vegetative plants within a hydroponic garden, completely ending root strangulation. There also exists a need in the art to provide an innovative solution that leverages thin-film materials to create a flexible and adaptable hydroponic system, offering enhanced portability, scalability, and ease of use. By introducing this new technology, the present invention aims to revolutionize the field of plant cultivation, enabling users to grow healthy plants in a more efficient, sustainable, and space-efficient manner.

### SUMMARY

The elastic hydroponic nursery pot apparatus of the present disclosure, also referred to a “modular vessel”, comes in various sizes, types, and configurations, making it a versatile alternative to traditional rigid basket-shaped structures like (U.S. Pre-grant Pub. No. 2015/0319946 A1). Unlike its predecessor, the elastic hydroponic nursery pot features no rigid bottom. Instead, the root bodies of the installed vegetation or seeded medium are held in place by an encapsulating circumference formed by the elastic force exerted by the elastic mesh tube that surrounds them.

The elastic hydroponic nursery pot, unlike the “foam puck”-shaped design disclosed in U.S. Pat. No. 10,517,241B1, is ideal for avoiding drought due to its capability of holding spongy lightweight substrate media, such as rock wool-a mineral-based medium commonly used in the industry. Other spongy mediums within the industry include various forms like rockwool, organic rooting medium and sponges. The elastic hydroponic nursery pot advantageously can retain any of these spongy medium substrates, enabling the growth of heavier plants than previous methods that only retained plants by pinching the stem.

The elastic hydroponic nursery pot also offers an advantage: it enables the use of “foam puck”-shaped debris covers as common practice in the industry with previous rigid basket-shaped designs. By incorporating this functionality, the new design maintains familiarity and continuity with established hydroponic gardening practices.

The elastic hydroponic nursery pot employs a mesh tube intentionally due to its ability to break before damaging the roots. This allows thicker root bodies to develop naturally and unrestricted. When the expansion of the elastic mesh exceeds its threshold and breaks, the circumference of the root aperture increases without compromising the apparatus.

The first roots produced by a seed are called “tap roots,” which typically grow straight down in search of moisture buried deep in soil. These types of root systems prefer to develop vertically, rather than horizontally through the mesh, making it essential that the body of the new apparatus remains an open, vertically situated tube at its base. Although sealing the bottom is an option, it is not beneficial or necessary as it simplifies installing and uninstalling root bodies by maintaining an open, mesh-covered bottom.

It is important to note that while tap roots grow downward initially, they may later develop secondary branches that penetrate the mesh for horizontal nutrient absorption. The elastic hydroponic nursery pot design accommodates these growth patterns effectively.

This innovative elastic hydroponic nursery pot can be easily reused after the transplanting process of vegetation to other systems, offering a significant advantage over traditional methods. Its design allows for easy removal from the root bodies of vegetation-simply expand the mesh and remove the vegetation from within the inner circumference of the expansion mount. The roots are easily separated from the pot without harm, enabling a quick release of the innovative elastic hydroponic nursery pot from the plants' roots in mere seconds.

The elastic mesh tubes employed in each application of the method can be permanently or removably affixed using various techniques.

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to introduce a unique elastic force-based holding method for seeds, vegetative root bodies, or spongy substrate medium within a hydroponic system.

It is still yet a further object, feature, and/or advantage of the present disclosure to form a thin-film system by folding a flexible, thin film in half like an envelope, creating a stable base structure that can be further configured into various shapes for plant cultivation.

It is still yet a further object, feature, and/or advantage of the present disclosure to create a stable growing point.

It is still yet a further object, feature, and/or advantage of the present disclosure to simplify transplanting with a reusable seed starter package.

It is still yet a further object, feature, and/or advantage of the present disclosure to reduce shipping weight.

It is still yet a further object, feature, and/or advantage of the present disclosure to provide a hydroponic garden that is compatible with standard industry gardens without modification.

It is still yet a further object, feature, and/or advantage of the present disclosure to eliminate root-bound growth and associated issues like strangulation.

It is still yet a further object, feature, and/or advantage of the present disclosure to minimize environmental impact due to the ease of removing the elastic element when necessary.

It is still yet a further object, feature, and/or advantage of the present disclosure to promote healthy, unrestricted root body growth and provides a healthy, unrestricted environment for root systems.

It is preferred that the hydroponic garden be safe and easy to ship, cost effective, and durable. For example, the improved hydroponic garden comprises a lesser shipping weight. Additionally, an elastic mesh is designed to support growing plants while allowing roots to break through, making for an easy removal process from the root system without damaging it.

Methods can be practiced which facilitate use, manufacture, assembly, maintenance, and repair of the hydroponic garden which accomplish some or all of the previously stated objectives.

For example, one such preferred method involves utilizing a circumference of constricting elastic forces that gently envelopes vegetative root systems. Another preferred method involves utilizing a circumference of elastic forces stabilizes and supports a vegetative root system within a hydroponic garden. Another preferred method involves utilizing Elastic expansion to enable vegetative root bodies to grow unimpeded through root apertures and drainage holes. Another preferred method involves utilizing elastic forces that are subtle and non-restrictive, allowing vegetative root bodies to grow unrestricted within the elastic potential. Another such preferred method involves utilizing the elastic forces naturally to release when outward force from growing vegetative root bodies exceeds the structural integrity of the source of elastic force, preventing damage to the rooting bodies. Another such preferred method involves utilizing the elastic forces are specifically designed to securely retain vegetative root bodies within the root chamber of a hydroponic garden while allowing them enough room to grow.

In another example, one such preferred assembly involves the use of one or more manufacturing methods such as: injection molding: which is used for creating both the elastic mesh and rigid attachment base components; a subsequent process that involves combining a pre-formed elastic mesh tube with the rigid attachment base using a heat process, resulting in a seamless integration of both parts; and an alternative process where an elastic mesh tube is produced by continuously extruding melted material through a die to create the desired shape and dimensions. It is important to note that while LDPE is currently the preferred material for the elastic hydroponic nursery pot, other materials that can further advance this technology may be discovered in future developments.

The hydroponic garden can be incorporated into systems or kits which accomplish some or all of the previously stated objectives.

The hydroponic garden disclosed herein can be used in a wide variety of applications. For example, the hydroponic garden can be used to grow pretty much every type of plant associated with hydroponics. The hydroponic garden works with typical gardening plants like strawberries and super rare jungle plants. The hydroponic garden can even be used to grow very rooty plants that you cannot grow easily with hydroponics like carrots, and the hydroponic garden can also be used with plants that require less water to grow such as cacti and succulents.

According to some aspects of the present disclosure, the expansion mount is modified by sinking the hooking method deeper into the inner circumference of the horizontal grow spot hole stabilizer. This can be achieved by creating an inner circumference of flat, upwardly pointing net hooks within the inner circumference of the horizontal grow spot hole stabilizer. This may not necessarily expand the mesh gracefully and only drapes the elastic mesh tube down, causing the stems and sprouts of plants to be somewhat submerged in the root chamber because the highest point of elastic force is always stronger in the center of the elastic tube, and this location can then be lowered by this type of mounting configuration.

According to some additional aspects of the present disclosure, the elastic mesh tube is mounted in the inner circumference of the horizontal grow spot hole stabilizer or inner circumference of the rim mount and is not expanded. While prototyping and researching this variation, it was found that the elastic expansion makes it much easier to install plants.

According to some additional aspects of the present disclosure, the inner circumference of the attachment base tapers the size of the grow spot hole inward slightly so that the rigid attachment mount is cone shaped pointing upwards to create area for a smaller grow spot hole that can be used to enable the use of smaller diameter elastic mesh tubes in larger grow spot holes.

According to some additional aspects of the present disclosure, a piece of metal is embedded within the rim mount to make it hold its shape when bent, so it will fit in various geometries of grow spot holes.

According to some additional aspects of the present disclosure, the modular vessel is made out of elastic low-density polyethylene, rubber, or similar elastic materials. Ideally, the material will not rot because the material does not absorb moisture.

According to some additional aspects of the present disclosure, the attachment base is made out of a rigid ABS, or polyethylene plastic, or a similar rigid plastic material. Ideally, the material will not rot because the material does not absorb moisture.

According to some additional aspects of the present disclosure, the modular vessel has a rim mount with a wider circumference than the circumference of the grow spot hole for supporting the apparatus and no horizontal grow spot hole stabilizer.

According to some additional aspects of the present disclosure, the elastic mesh is designed to separate or reattach from the attachment base.

According to some additional aspects of the present disclosure, the expansion mount has a small arch under the rim mount. This greatly increases the geometric stability of the rim mount.

According to some additional aspects of the present disclosure, the mesh is designed to separate or reattach from the circumference of a modified grow spot hole.

According to some additional aspects of the present disclosure, the modular vessel is made with the mesh tube permanently expanded and attached in a non-removable way.

According to some additional aspects of the present disclosure, the entire modular vessel in all its forms can be 3D printed using various levels of thickness to create rigidity, and by using two or more types of plastics to create the entirety of the apparatuses described herein.

According to some additional aspects of the present disclosure, elastic mesh tubes are remolded into the preferred shape. Remolding creates thicker areas of the elastic material that are more rigid.

According to some additional aspects of the present disclosure, the entire body of the modular vessel is manufactured in an injection molding process.

According to some additional aspects of the present disclosure, the expanded mesh tube is attached to the attachment base temporarily by means of clamps, threading, or by using a series of pegs or hooks that hold the mesh onto the expansion rim mount physically attaching the mesh.

According to some additional aspects of the present disclosure, the expanded mesh tube is attached to the attachment base permanently by means of glue or over-molding (process of injection molding).

According to some additional aspects of the present disclosure, the elastic mesh can be formed into a pocket shape by heat sealing the bottom aperture closed. However, this is not necessary in embodiments where the plant is best retained within the center of the elastic potential and not at the bottom of the apparatus.

According to some additional aspects of the present disclosure, the elastic mesh is formed into a tube and then melted to the shape of the attachment base.

According to some additional aspects of the present disclosure, the elastic mesh is formed into a funnel shape.

According to some additional aspects of the present disclosure, vegetative root bodies are held in by a circumference of constricting elastic force.

According to some additional aspects of the present disclosure, vegetative root bodies are held within an apparatus supported by an expanded circumference of elastic force.

According to some additional aspects of the present disclosure, vegetative root bodies are intended to grow through the root apertures of the elastic mesh.

According to some additional aspects of the present disclosure, the attachment base is intended to be permanently attached to the mesh or molded within the grow spot hole.

According to some additional aspects of the present disclosure, a hydroponic garden is intentionally manufactured with an expansion mount to the edge of the grow spot hole itself with the intent to hold an elastic mesh.

According to some additional aspects of the present disclosure, the mesh was permanently attached or molded within the grow spot hole.

According to some other aspects of the present disclosure, a method for holding vegetation in a hydroponic system using an elastic force, the method comprises providing an elastic element configured to expand and contract; attaching the elastic element to a support structure; positioning the vegetation between the elastic element and the support structure, with vegetation roots of the vegetation in contact with a nutrient solution; applying a force to the elastic element, causing the elastic element to expand and hold the vegetation against the support structure; and releasing the force on the elastic element, allowing the elastic element to contract and maintain tension on the vegetation, thereby securing it in place during cultivation.

According to some additional aspects of the present disclosure, the elastic force is created around vegetative root bodies.

According to some additional aspects of the present disclosure, the elastic force is intended to maintain and support vegetative root bodies within a root chamber of a hydroponic garden.

According to some additional aspects of the present disclosure, the elastic force is capable and intended to retain and support various spongy substrate mediums, and vegetative root bodies of various living plants in a hydroponic garden.

According to some additional aspects of the present disclosure, the method is utilized in a modular apparatus like a traditional hydroponic pot.

According to some additional aspects of the present disclosure, the elastic potential is composed of compressing forces (constricting elastic forces) compressing the root bodies.

According to some additional aspects of the present disclosure, the elastic potential is composed of expanding elastic forces supporting the root bodies.

According to some other aspects of the present disclosure, a hydroponic gardening system with a grow spot hole designed and formed to retain and expand an elastic mesh tube through either a permanent or a temporary fastener, the hydroponic gardening system comprising: an expansion mount integrated into an attachment base; an elastic expansion forming part of the expansion mount within the attachment base; an inner void located between a top aperture and a bottom aperture; an elastic potential provided through the elastic expansion and transmitted to the vegetation via the grow spot hole design; a grow spot hole shaped and adapted to fasten to, retain, and expand the elastic mesh tube; and net hooks connected to a net hook base positioned within the inner void.

According to some additional aspects of the present disclosure, the fastener is selected from the group consisting of hooks, pegs, and groves, wherein the fastener engages with the elastic expansion or mesh tube to facilitate proper retention and expansion during use.

According to some additional aspects of the present disclosure, the attachment base encompasses a grow spot hole in a non-modular and non-removable manner.

According to some other aspects of the present disclosure, a thin-film hydroponic system that enables plant cultivation comprises a root chamber and/or a nutrient reservoir; a flexible, thin film that is folded and structured to be folded so as to hold vegetation in a grow hole, without the use of soil. The flexible, thin film has a re-configurable shape and has no rigid external or internal structure.

According to some additional aspects of the present disclosure, the flexible, thin film can be folded into a square configuration.

According to some additional aspects of the present disclosure, the flexible, thin film is clear.

According to some additional aspects of the present disclosure, the flexible, thin film includes a first side that is black.

According to some additional aspects of the present disclosure, the flexible, thin film includes a second side that is white.

According to some additional aspects of the present disclosure, the flexible, thin film is configured to be folded into a modular unit, allowing multiple units to be interconnected to form a scalable hydroponic system for cultivating plants of varying sizes or types.

According to some other aspects of the present disclosure, a method of creating a hydroponic garden from the thin-film hydroponic system described above comprises folding the flexible, thin film into a stable shape for cultivating plants. The hydroponic garden comprises a plant placed into the grow spot hole, the flexible, thin film, and the root chamber or the nutrient reservoir.

According to some additional aspects of the present disclosure, the method further comprises folding a middle of an envelope of the flexible, thin film by pulling open upper pieces of the flexible, thin film from a center of the flexible, thin film and drawing the upper pieces outward into an X-shaped configuration.

According to some additional aspects of the present disclosure, the method further comprises welding ends of the symmetrical X-shaped configuration at inward angles.

According to some additional aspects of the present disclosure, the method further comprises selecting a thermoplastic material for the flexible, thin film from the group consisting of: a high-density polyethylene (HDPE), a linear low-density polyethylene (LLDPE); and a low-density polyethylene (LDPE).

According to some additional aspects of the present disclosure, selection is based on being able to provide enough resistance to acidic hydroponic nutrients with corrosive pH levels.

According to some additional aspects of the present disclosure, said selection is based on having a high enough tolerance against UV radiation exposure.

According to some additional aspects of the present disclosure, the elastic element is configured to dynamically adjust its tension and aperture size in response to the growth of the vegetative root bodies, thereby accommodating varying root system sizes and growth stages without requiring replacement or manual adjustment of the elastic element.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows a side view of the modular elastic hydroponic nursery pot apparatus formed of one part.

FIG. 2 shows a perspective view of the modular elastic hydroponic nursery pot apparatus formed of one part.

FIG. 3 shows a top view of the modular elastic hydroponic nursery pot apparatus formed of one part.

FIG. 4 shows a cutaway view of the modular elastic hydroponic nursery pot apparatus formed of one part.

FIG. 5 shows a bottom view of the modular elastic hydroponic nursery pot apparatus formed of one part.

FIG. 6 shows a side view of modular elastic hydroponic nursery pot apparatus formed of two parts.

FIG. 7 shows a cutaway view of the modular elastic hydroponic nursery pot apparatus formed of two parts.

FIG. 8 shows a top view of the modular elastic hydroponic nursery pot apparatus formed of two parts.

FIG. 9 shows a bottom view of the modular elastic hydroponic nursery pot apparatus formed of two parts.

FIG. 10 shows a side view of the attachment base.

FIG. 11 shows a top view of the attachment base.

FIG. 12 shows a bottom view of attachment base.

FIG. 13 shows a cutaway side view of the attachment base.

FIG. 14 shows a perspective view of an Elastic mesh tube.

FIG. 15A shows a zoomed in side view cutaway comparing the growth of a single root body through a rigid root aperture.

FIG. 15B shows a zoomed in side view cutaway comparing the growth of a single root body through an unrestricted elastic root aperture.

FIG. 16 shows a perspective black and white drawing showing a Kratky method hydroponic garden using the new apparatus with spongy medium and vegetation installed.

FIG. 17 shows a cutaway side view of attachment base without a Horizontal grow spot hole stabilizer.

FIG. 18 shows a side view Cutaway of the variation of the apparatus where the Mesh tube is directly connected to the sides of the grow spot hole of the hydroponic garden.

FIG. 19 shows a side view of an elastic mesh tube.

FIG. 20 shows a top or bottom view of an elastic mesh tube.

FIG. 21 shows a cutaway side view of a grow spot hole that has been created with an attachment base with a removable elastic mesh tube.

FIG. 22 shows an x-ray view of the side of an flexible film hydroponic garden.

FIG. 23 shows a solid view of the side of the flexible film hydroponic garden of FIG. 22.

FIG. 24 shows a top view of the flexible film hydroponic garden of FIG. 22.

FIG. 25 shows a square variation of a flexible film hydroponic garden.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

Multiple variations of the “elastic hydroponic nursery pots” were considered in the development process, and while not limited to these two properties, the primary differences between embodiments can be attributed to their modular construction.

The elastic mesh tube designed for use in hydroponic systems is made from a stretchable material that can accommodate growing roots while retaining its original shape once the roots reach maturity or are removed. The material must be both durable enough to endure the growth process and flexible enough to adapt to varying root sizes.

The elastic mesh is preferably manufactured from an elastic material such as Low Density Polyethylene (LDPE), using an injection molding process to create its shape. The advantages of LDPE for this application include being non-toxic, heat-resistant, and stable under sunlight and high pH nutrient solutions. However, alternative elastic materials that offer enhanced properties or manufacturing benefits may be used in the future.

These designs offer several advantages. The elastic mesh tube keeps the growing roots in place, preventing them from falling into the root chamber and ensuring proper plant development. The simplicity of transplanting mature plants using an elastic material for root confinement reduces damage to their roots due to its adaptive nature. Additionally, the controlled growth environment provided by the elastic mesh tube enhances nutrient absorption efficiency and supports uniform plant growth. Furthermore, the reusable nature of the elastic mesh tube reduces overall production costs compared to disposable alternatives, offering significant savings. Lastly, as the elastic mesh tube breaks down with the maturing root system, it minimizes waste and decreases environmental impact.

A typical elastic mesh design incorporates diamond-shaped apertures, which are formed by thermally bonded 1 mm thick filaments. These untouched apertures provide a 5 mm empty space and full elastic potential on both sides. When stretched, individual apertures expand to at least 20 mm before breaking. Additional broken apertures within the same break usually extend only about 10 mm more due to surrounding strand support. This balance between expansion and stability prevents root strangulation while maintaining plant position in the apparatus.

The diamond shaped mesh apertures were deliberately chosen for its “root-yoking” benefits, allowing lower root cusps to interlock with mesh aperture bottoms, ensuring stable growth and proper alignment as roots pass through. Furthermore, this design is cost-effective for manufacturing. Research has shown that various root structures thrive in most mesh patterns, but the diamond-shaped elastic mesh stands out due to its stability from “root-yoking,” ease of root separation, and affordability.

Root-yoking ensures that as the vegetation grows, its roots will naturally become entangled within the apertures of the elastic mesh, further enhancing stability for the developing plant within.

Root systems growing in the elastic mesh will gradually adjust individual strands as they grow, optimizing stability within the tube over time. Elastic forces are equalized and redistributed through root growth, making the tube function like a tube of rubber bands. When vegetation is introduced, the inward squeezing force of the elastic mesh counteracts gravity on the growing root bodies, ensuring they maintain a stable location without restriction.

The lack of a bottom to this elastic tube allows tap roots to grow freely while containing other roots in place. This elastic force offers optimal support with minimal resistance to growing roots.

Elastic vessels, such as our elastic hydroponic nursery pot, contrast traditional rigid containers like pots, cups, baskets, boxes, or bowls. Instead of retaining a fixed volume when empty, an elastic vessel's size contracts. This difference is significant because the container's capacity, defined by its elastic deformation capability before failure, governs the available space—referred to as elastic potential.

Elastic potential represents the maximum storage capacity of the elastic hydroponic nursery pot when no force is applied. When no roots or medium are present within the container, the Elastic potential is at 100%. As root bodies expand and fill the inner void of the pot, a portion of the Elastic potential is utilized to accommodate their growth, leaving the remaining space available for further expansion.

Considering an analogy with a balloon, when deflated, it occupies minimal space and has 100% Elastic potential. However, as air is introduced and the balloon inflates, the Elastic potential diminishes, and eventually reaches zero when the balloon is near bursting-exceeding its maximum elastic force capacity. This same principle applies to our elastic mesh tube that surrounds and supports the roots and substrate within the pot.

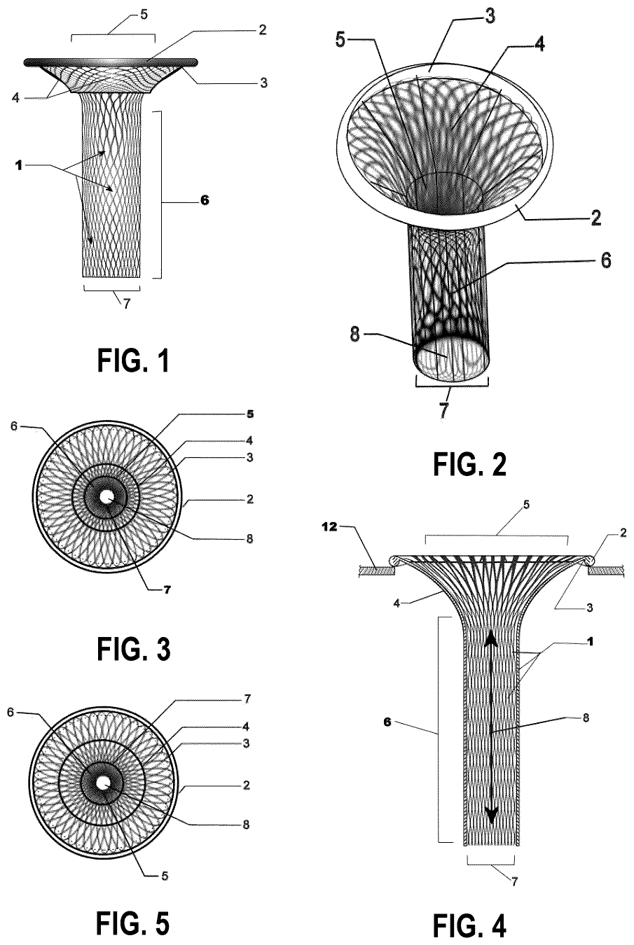

The first embodiment shown in FIGS. 1-5 is designed without the intent of the elastic mesh being removable from the expansion mount, creating a more cohesive structure that functions as an integral part of the pot.

The first variation of the preferred “elastic hydroponic nursery pot” is designed as a single, monolithic vessel. This design can be produced through various methods including injection molding using a single elastic material, over-molding multiple materials with varying rigidities into a single part, or 3D printing with elastic materials like TPE (thermo-plastic elastomer) or rubber fabrication processes. The monolithic construction of this embodiment results in a unified structure that offers strength and durability while effectively accommodating root growth through its elastic properties.

The current version of the 3-inch circumference elastic hydroponic nursery pot uses a single piece of elastic mesh tubing as it is material. Various lengths of this elastic tube reproduced the method, mesh segments that worked without wasting too much material were under 10 inches long. This elastic mesh tubing, with an initial diameter of 2 inches and a potential expansion diameter of 4 inches, is employed for the creation of the elastic hydroponic nursery pot that fits into standard 3″ holes. Smaller diameter mesh for 2″ standard holes wasn't used because the seed starter package made for the 3″ expansion fit perfectly in the 2″holes. The mesh for the 3″ can also be stretched to Larger 4″ holes but a mesh with about 3 inches of initial diameter work better to create an apparatus for larger grow spot holes.

The first variation of the apparatus can also be manufactured as a single bodied unit by permanently attaching parts and bodies together using processes like overmolding, adhesives, or thermal bonding. This eliminates the need for manual assembly. Such a variation of the new apparatus comprises all parts (rim mount, expansion mount, and mesh tube) made as one body without any intent for separation or removal. In this case, the attachment base is not mentioned because it doesn't exist as a separate entity.

After thorough consideration, the most favorable method for constructing the single body variation of the “elastic hydroponic nursery pot” is accomplished by expanding and heat-treating the ends of the radial expanded end section of a preformed extruded elastic mesh tube. To achieve this:
1. The mesh tube's ends are expanded to create the desired shape and dimensions for the expansion mount 3.
2. Heating the expanded ends is essential, but protecting the rest of the tube from heat damage by shielding it within an insulating tube only allowing the expanded section to be melted outside of the insulating tube.
3. As the circumference of plastic outside of the shielding melts during the heat treatment process, its pushed down over an edge with a rounded lip that molds an inner arch.
4. The elastic plastic quickly shrinks when cooled into the thicker shape this increased thickness creates a rigid expansion mount.
   By following this procedure, a strong and durable elastic hydroponic nursery pot can be produced with an integral expansion mount that effectively supports vegetative growth.

The mounting portion incorporates a circumferential rim mount 2, which has a larger circumference diameter than the grow spot hole, enabling the present embodiment to rest on top of the root chamber. This prevents the hydroponic nursery pot and its contents from falling into the root chamber below but keeps them suspended within.

The elastic hydroponic nursery pot is structured as follows. The expansion mount 3 is where the elastic mesh is attached or formed, comprises an inner circumference that tightly expands open the mesh. The expansion mount creates elastic expansion 4. This expansion is the area of the mesh that is expanded by the expansion mount and has a funnel shape that tapers inward from the edges towards the root chamber. The inner circumference of this funnel or tube-shaped elastic mesh forms the inner void 8, the inner part of the container where plants' roots or seeded substrate medium are disposed.

The expansion mount 3 comprises of an inner circumference that tightly expands open the mesh. This expansion creates the elastic expansion 4, which is the area of the mesh that is expanded by the expansion mount and has a funnel shape that tapers inward from the edges towards the root chamber. The inner circumference of this funnel or tube-shaped elastic mesh forms the inner void 8.

The installed plant is situated with branches and leaves above the top aperture 5. This top aperture serves as the boundary between the subterranean root apertures 1, and the elastic expansion 4. The elastic expansion 4 forms a strong configuration suitable for mounting to the expansion mount, creating a trumpet-shaped funnel with an inner circumference that forms the inner void 8 to insert vegetative root bodies and seeded substrate medium into through the top aperture 5.

The top portion of an installed plant is situated with branches and leaves above the top aperture 5. The top aperture 5 serves as the boundary between the subterranean root apertures 1, and the elastic expansion 4. The elastic expansion 4 forms a strong configuration suitable for mounting to the expansion mount, creating a trumpet-shaped funnel with an inner circumference that forms the inner void 8 to insert vegetative root bodies and seeded substrate medium into through the top aperture 5.

Where the elastic is no longer expanded is the area of elastic potential 6, where vegetative root bodies and seeded substrate medium inserted into the inner void 8 are vertically situated in the middle of this elastic potential 6. This is because the force of elastic pressure is greatest at that point, located at least a half inch above the bottom aperture 7.

The expanded circumference of the net acts as the functional installation point for inserting vegetation, i.e. the expansion area 3. To install living plants and spongy medium, place the apparatus on a flat surface like a sleeve with the expanded area facing upwards. Grasp a handful of roots or plants along with their substrate medium, if present, and gently slide the apparatus over your hand until the root bodies and medium are situated within the area of greatest elastic potential 6. Remove your hand carefully while allowing any long roots to pass through the bottom aperture 7, then place the apparatus into a grow spot hole.

Live plants and spongy medium are disposed into the inner void 8 within the area of elastic potential 6. Roots can grow out of the bottom aperture 7, as well as through a plurality of apertures in the elastic mesh 1. Vegetative root bodies and seeded substrate medium inserted into the inner void 8 are vertically situated in the middle of this elastic potential 6, which is located at least a half inch above the bottom aperture 7.

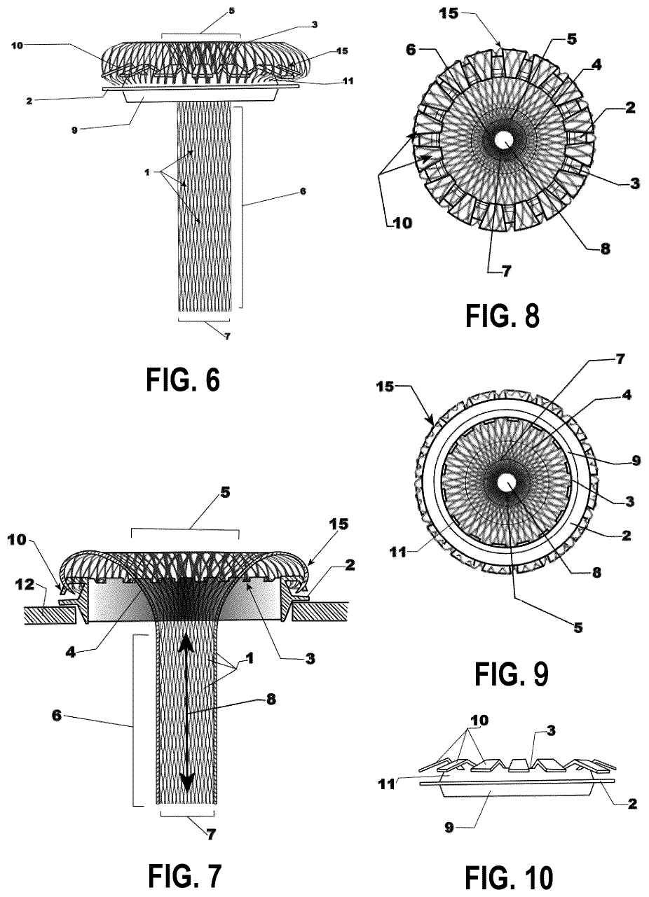

The second embodiment of the present disclosure is designed for manual attachment and detachment of the elastic mesh tube to accommodate applications such as an elastic seed starter package, as shown in FIGS. 6-9. In this configuration, the mesh tube is folded into itself several times with a spongy substrate inside. So that it can fit in a seed starter tray and the 2″ holes that are standard in smaller hydroponic gardens.

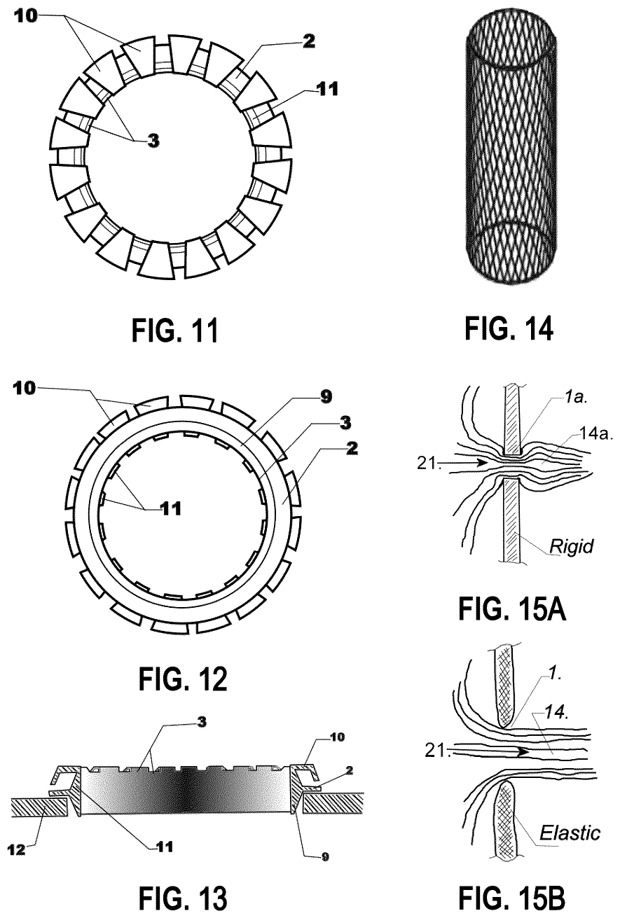

In the second variation of the preferred “elastic hydroponic nursery pot,” an “Attachment Base” (FIGS. 10-13 and FIG. 17) is utilized, which comprises both a rim mount and expansion mount. Optionally, this attachment base may include a “horizontal grow spot hole stabilizer” 9, designed to enhance stability during the mounting of the apparatus within the grow spot hole 12. This stabilizer is not essential for the functionality of the method but serves as an additional feature for improved stability in certain situations. The attachment base can also be integrated into the garden setup and remain non-removable depending on specific application requirements.

Net hooks 10 serve to attach the elastic mesh to a supporting structure like a container or a frame. By using a rigid attachment base material, the net hooks are sturdy enough to maintain their position and support the weight of the elastic mesh and any additional load the net hooks 10 may bear during use.

The net hook base 11 refers to the area at the base of each net hook where they are securely attached. The inner wall of the net hook base plays a significant role in enabling the use of foam lids for various purposes, such as preventing debris from entering the hydroponic nursery pot or container.

The use of an elastic seed starter package enables users to sprout or clone their plants in smaller seed trays and smaller 2″ grow spot holes before transferring them into the elastic hydroponic nursery pot system. This configuration offers increased flexibility and adaptability to various growing environments and production processes.

Unless the attachment base is integrated into the root chamber surrounding the grow spot hole, its shape should be larger than the grow spot hole's diameter to prevent the plant from falling into the root chamber 13.

In the context of the new invention, the attachment base (FIGS. 10-13 and FIG. 17) is a functional identifier within the apparatus, but it may not be physically separate if integrated into the hydroponic garden as a feature.

In the second variation of the preferred “elastic hydroponic nursery pot,” an “Elastic Mesh tube” (FIG. 14 and FIGS. 19-20) and an “Attachment Base” (FIGS. 10-13 and FIG. 17) are used. The user expands the elastic mesh tube to a larger diameter manually before attaching it to the expansion mount and rim mount on the detachable “Attachment Base” (FIGS. 10-13 and FIG. 17).

Following these steps:
1. The user manually expands the elastic mesh tube to a larger diameter.
2. The expanded elastic mesh tube is then attached to the expansion mount and rim mount on the detachable “Attachment Base” (FIGS. 10-13 and FIG. 17).
3. Once connected, the elastic hydroponic nursery pot is formed, ready for use in plant growth applications.
   This design offers flexibility and ease of use by allowing users to replace or modify the elastic mesh tube as needed for optimal plant growth in various conditions.

During the production of the attachment base component, it's essential that a more rigid material than the one used for creating the elastic mesh is employed. This is crucial since a less rigid material may not be able to provide adequate support and stability for the net hooks, potentially leading to inadequate load-bearing capacity.

During prototyping, alternative temporary methods included clamping, sewing, or pinching the mesh to the rigid mounting circumference of the Attachment Base in a removable way. Although these approaches succeeded in reproducing the method of the innovative elastic hydroponic nursery pot, they employed more complex methods containing additional parts that were not as preferred as hooking the apertures over the wide, flat hooks.

Through extensive research we discovered that hooking the apertures of the elastic mesh (FIG. 14 and FIGS. 19-20) over an outward facing circumference of wide, flat hooks is the most preferred attachment method for users and the job when connecting the elastic mesh tube to the attachment base (FIGS. 10-13 and FIG. 17). This simple attachment approach offers several benefits. First since it has no moving parts or extra parts to manufacture and assemble it simplifies the design process for the Attachment Base, reducing its complexity. The required parts count decreases, resulting in a more cost-effective solution. This method can be key in establishing the attachment base as a fundamental component within the elastic hydroponic nursery pot system.

When designed for removable elastic mesh tubes (FIGS. 6-9), the inner area of the circumferential rim mount 2 is where the elastic mesh tube is expanded and attached. In one embodiment, the mesh is secured within a circumference of net hooks 10 that hold the expanded end of the elastic mesh tube open. The attached elastic mesh is evenly disposed within the inner circumference of the rim mount and set into the root chamber.

The roots grow larger in circumference than the elastic potential 6 of the initial circumference of the elastic mesh tube, resulting in an elastically static containment within the inner circumference for a period. As the roots reach maturity or outgrow the mesh container, they slowly degrade parts of the elastic material 24.

The expanded, mounted elastic mesh tube is situated around the edge of the grow spot hole 12. By hanging suspended within the center of the hole, it maintains the inner void 8 of the apparatus. Grow spot hole size can vary and likewise the mesh can be sized to fit any diameter grow spot hole, allowing the new elastic hydroponic nursery pot to be utilized in most hydroponic gardening equipment currently available in the market while offering improved plant growth support and irrigation functionality through an adaptable elastic force.

Another problem solved by the present invention is the very rigid root apertures of the prior art that cause damage to growing roots. The solution is to design the root level structures using an elastic material that bends and flexes with root bodies without any restriction.

Regarding devices that rely on gravity for retaining planted vegetation and heavy substrates, this invention introduces an elastic method to retain the plant while utilizing a spongy, lightweight substrate medium. This solution makes shipping easier and allows the device to function effectively even in zero-gravity conditions with larger plants.

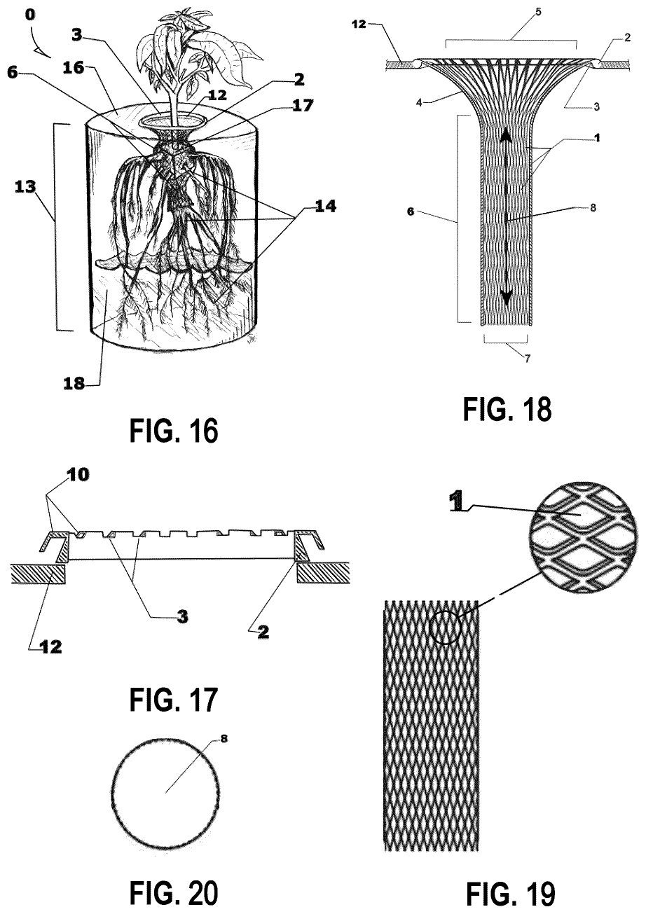

As shown in FIG. 16, modular vessels are inserted into individual grow spot holes 12 positioned atop root chambers 13. A single grow spot hole 12 refers to the designated location within a hydroponic garden for an individual hydroponic nursery pot. This is where roots access the nutrient-rich solution. In all cases, grow spot holes 12 are situated atop root chambers. The nutrient solution may be housed in a separate reservoir or integrated directly into the root chamber. Due to hydroponic gardens' diverse nature, grow spot hole 12 shapes can vary—they may be square, rectangular, triangular or most frequently, circular. Circular holes are favored due to their simplicity in production using standard hole saws among hydroponic practitioners. Typical hole sizes when fabricating a hydroponic garden include 2″ and 3″ diameter, commonly used for cloning or growing small plants like herbs, spices, and table-top vegetables. Larger holes, greater than 3″, are typically employed for overwintered plants, mature mother plants, or larger vegetation.

The root chamber 13 is the area where nutrients are applied to plant roots via various techniques. This enclosed chamber prevents nutrient solution leakage. In FIG. 16, the root bodies 14 interact with the nutrient solution 18. The root chamber 13 is sealed on all sides except for any top apertures formed as grow spot holes or for maintenance, testing, and adding nutrient solutions.

Bare root bodies or a seeded spongy medium like rock wool 17 are installed and situated vertically within the center of the inner void 8, within the area of inward elastic potential 6, and under the top aperture 5. Upon installation, the vessel's bottom may extend into or slightly above the “liquid nutrients” 18.

Unless directly integrated into the lid of the hydroponic garden in a non-removable fashion, When the elastic hydroponic nursery pot is placed into a grow spot hole 12 in a hydroponic garden, its inner void 8 and elastic potential 6, along with the bottom aperture 7, are positioned within the root chamber 13. Bare root bodies or a seeded spongy medium like rock wool 17 are installed and situated vertically within the center of the inner void 8. With the elastic potential 6 enveloping the circumference of the root bodies 14 and substrate, lower roots are encouraged to drape down through the bottom aperture 7. The part of the new invention that extends beyond the grow spot hole and supports the entire hydroponic nursery pot above it while maintaining elastic mesh tube stability within the hole is referred to as the rim mount 2.

As shown in FIG. 19, elastic compression holds the inner root bodies securely, while the elastic expansion of the elastic mesh material is advantageously utilized by vegetative roots to grow unrestricted through root apertures 1, created naturally by the lattice structure of the elastic mesh.

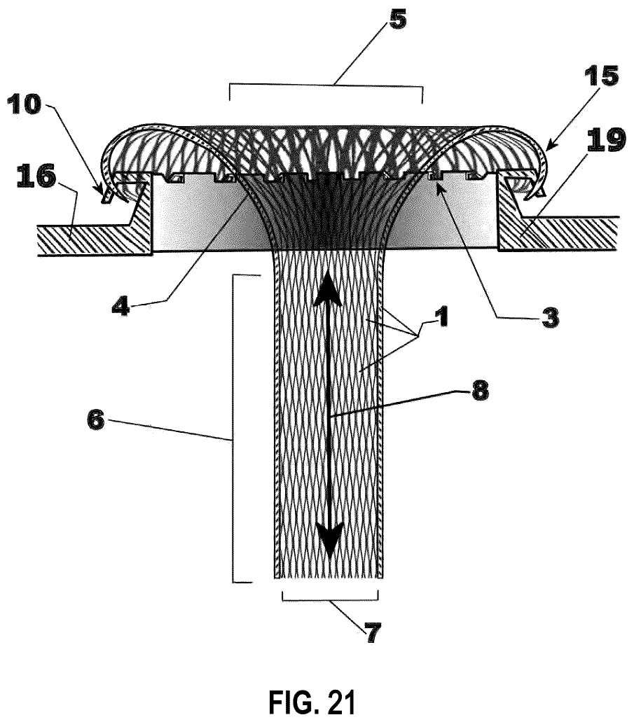

The present disclosure utilizes a unique method for growing vegetative root systems 14 using elastic forces, wherein an elastic mesh tube with an inner void 8, as shown in FIG. 20, is employed to confine and support the roots while allowing for natural growth expansion and eventual planned containment failure. The tube has an elastic potential 6 with a tall and thin shape, with a horizontal placement of root apertures 1 designed to encase the root systems, as shown in FIG. 21. The grow spot hole that has been created with an attachment base with a removable elastic mesh tube has a point 19 where the grow spot hole forms a non-modular attachment base with permanency in it is structure.

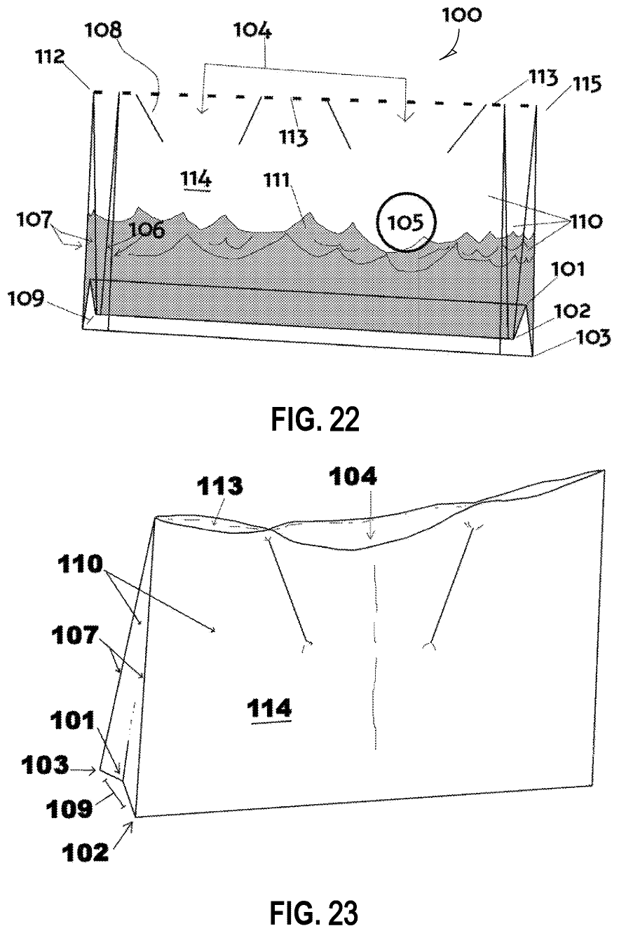

FIG. 22 shows a novel, thin-film hydroponic system 100 that enables plant cultivation in a flexible, re-configurable, and lightweight apparatus. The apparatus created by this method uses a flexible, thin film material specifically designed for plant growth. This unique property allows it to adapt to changing environmental conditions, providing optimal growing conditions.

The apparatus incorporates a thin film sheet 114 made from a thermoplastic material selected from among high-density polyethylene (HDPE), linear low-density polyethylene (LLDPE) and low-density polyethylene (LDPE). The specified thickness range for this film is approximately three to six millimeters (3-6 mm). It is worth noting that the chosen thermoplastic material can be selected based on being able to provide enough resistance to acidic hydroponic nutrients with a corrosive pH level and the material selected must also have a high enough tolerance against UV radiation exposure so the apparatus does not degrade.

Various opacities of film can be used depending on the intended crop and location of the garden. Clear is good for studying root systems in cooler places, Black is also intended for cooler places but is better for root health. Double sided black and white Panda film was found to be the best for warmer or outdoor climates. Panda Film works the best in most cases. This film has a critical role in the system, providing optimal light transmission and absorption properties on its white side and minimizing algae growth on its black side. The unique combination of these properties enables enhanced nutrient delivery, precise temperature control, and minimized contamination risk.

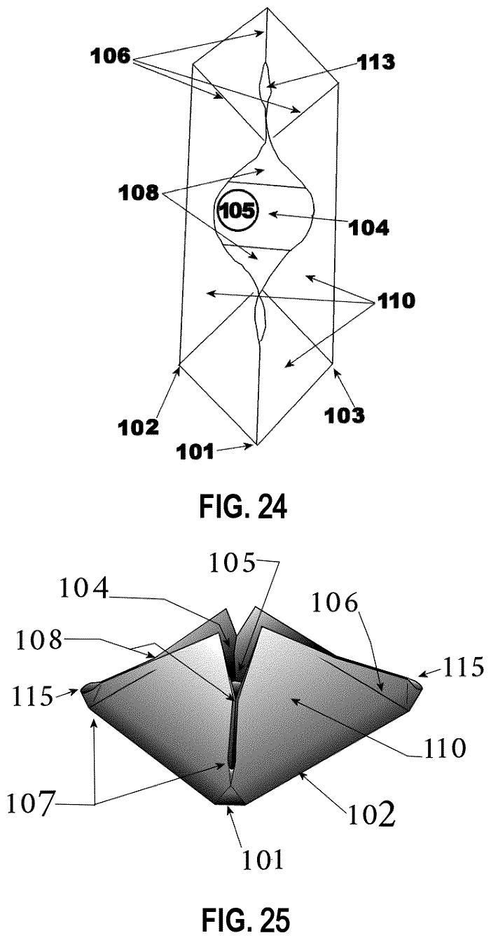

This sheet of film 114 is cut to a desired length, usually over one foot (1 ft), and folded into sections approximately one foot (1 ft) tall. The initial step involves folding the thin film in half like an envelope, creating a pocket that supports the root chamber and nutrient reservoir, as shown in FIGS. 22-24. This base structure can then be modified into square or X-shaped configurations.

As shown in FIGS. 22-24, the folds 101, 102, 103 take the shape of a W-shaped taco, because of the upward one-inch (1″) deep crease in the middle stabilizing bottom fold 101. Then, the side ends 107 are welded vertically 106 to form a pocket. Two weld areas 108 are added at perpendicular angles to each other on the top of the pocket 112, creating a small inward ledge. Each ledge Creates a grow spot hole 104 that directs roots into the root chamber 105 through a 1 inch hole in the bottom of the ledges leading to the root chamber 105, Grow spot holes 104 allow for root bodies and seeded medium to have a stable insertion point above the root chamber 105.

The entire apparatus can be hung via holes at the upper ends 115; however, as long as it contains liquid nutrient solution 111 like the thin-film hydroponic system 100 should, the thin-film hydroponic system 100 can also be seated upright on the ground. The bottom of the pocket 101, 102, 103 allows the solution to spread out, making it more stable due to a 1-inch portion of the pocket being folded inward 101. This enables the thin film pot to stand independently without hanging. By utilizing this inner bottom fold 101 that utilizes the liquid 111 to form a stable geometric platform, it can function without any rigid structure. Also, additional welds can create various chambers within containing nutrients or PH correction fluids or air channels for aeration. Note that a nontoxic substrate can also be added into the root chamber 105 to weigh it down and limit movement in case the plant runs out of water.

Instead of welding sealed areas at the top of the pocket, an elastic mesh tube is attached to the film material, creating a unique solution for plant growth. With several benefits to the garden. Such as holding the film open wider at the top for moisture collection. And helping to stabilize the roots within the apparatus because the plant has a firmer grip within the garden. Elastic mesh tube net pots and seed starter apparatuses fit naturally into the grow spot hole that is designed to accommodate two-inch to four-inch (2″-4″) pots.

In the square single grow spot variation shown in FIG. 25, the film 114 is formed into a single, self-standing thin-film vessel (such as a vase) that is stabilized by its inner contents, conforming to a geometric configuration provided by the film. This variation has only one top aperture 104. Its geometric shape supports plants and holds nutrient solutions in a unique way that utilizes the mass of the nutrient solution and the installed vegetation to maintain a stable, beneficial location for growing vegetation in accordance with this new, unique method. Although not necessary, it can also use an elastic method. The square-shaped flexible garden can likewise use standard media (such as rock wool blocks) inserted through the top aperture, with the roots suspended in the nutrient solution 111 below.

To create this variation, the middle of the film envelope is folded an additional time by pulling open both upper pieces of film from the center and drawing them outward into an X-shaped configuration when viewed from above. The ends of this symmetrical X-shaped configuration are welded at inward angles. In this variation, the weld placement combines the plant holder 108 (perpendicular ledge weld location) and the side welds 106 into a single entity.

Each configuration 0, 100 other than the square single grow spot variation shown in FIG. 25 can accommodate multiple grow spots 104. All configurations including the square single grow spot variation can utilize various hydroponic methods, such as the Kratky Method or DWC (Deep Water Culture) Method. The addition of an airline and air pump enables these configurations to be easily converted. By positioning them at angles, it is possible to use these variations for NFT (Nutrient Film Technique) rails if a bottom pump is added.

From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 0 | hydroponic garden |
| 1 | root apertures of the elastic mesh tube |
| 1a | rigid root apertures of the previous basket shaped art |
| 2 | rim mount |
| 3 | expansion mount |
| 4 | elastic expansion |
| 5 | top aperture |
| 6 | elastic potential |
| 7 | bottom aperture of elastic mesh |
| 8 | inner void of elastic mesh |
| 9 | horizontal grow spot hole stabilizer |
| 10 | net hooks |
| 11 | net hook base |
| 12 | edge or center of grow spot hole |
| 13 | root chamber |
| 14 | root bodies |
| 14a | damaged root body caused by strangulation or root bound |
| 15 | elastic mesh |
| 16 | top deck of root chamber |
| 17 | a cube of spongy substrate medium |
| 18 | a liquid nutrient solution |
| 19 | point where the grow spot hole forms a non modular |
| | attachment base with permanency in it is structure |
| 20 | point where Elastic Mesh is molded/over molded within |
| | the grow spot hole permanently |
| 21 | direction of root body growth (starting From base of |
| | root body to the end of root body) |
| 22 | lattice of elastic strands |
| 23 | rigid material |
| 24 | elastic material |
| 100 | thin-film hydroponic system |
| 101 | stabilizing bottom fold |
| 102 | outer bottom fold “A” |
| 103 | outer bottom fold “B” |
| 104 | grow spot hole opening |
| 105 | root chamber/nutrient solution reservoir |
| 106 | side welds |
| 107 | side ends |
| 108 | plant holder, perpendicular large welds |
| 109 | space created from bottom inner fold that allows the |
| | bottom to spread out |
| 110 | flexible film side walls |
| 111 | nutrient solution |
| 112 | top connecting fold |
| 113 | additional access opening for probes and air hoses |
| 114 | thermoplastic film |
| 115 | hanging holes |

### GLOSSARY

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A thin-film hydroponic system that enables plant cultivation comprising:
a root chamber and/or a nutrient reservoir;
a flexible, thin film that is folded and structured to be folded so as to hold vegetation in a grow hole, without the use of soil;
wherein the flexible, thin film has a re-configurable shape and has no rigid external or internal structure.

2. The thin-film hydroponic system of claim 1, wherein the flexible, thin film can be folded into a square configuration.

3. The thin-film hydroponic system of claim 1, wherein the flexible, thin film is clear.

4. The thin-film hydroponic system of claim 1, wherein the flexible, thin film includes a first side that is black.

5. The thin-film hydroponic system of claim 4, wherein the flexible, thin film includes a second side that is white.

6. The thin-film hydroponic system of claim 1, wherein the flexible, thin film is configured to be folded into a modular unit, allowing multiple units to be interconnected to form a scalable hydroponic system for cultivating plants of varying sizes or types.

7. A method of creating a hydroponic garden from the thin-film hydroponic system by folding a flexible, thin film into a stable shape for cultivating plants, said hydroponic garden comprising a plant placed into a grow spot hole, the flexible, thin film, and a root chamber or a nutrient reservoir.

8. The method of claim 7, further comprising folding a middle of an envelope of the flexible, thin film by pulling open upper pieces of the flexible, thin film from a center of the flexible, thin film and drawing the upper pieces outward into an X-shaped configuration.

9. The method of claim 7, further comprising welding ends of the symmetrical X-shaped configuration at inward angles.

10. The method of claim 7, further comprising selecting a thermoplastic material for the flexible, thin film from the group consisting of: a high-density polyethylene (HDPE), a linear low-density polyethylene (LLDPE); and a low-density polyethylene (LDPE).

11. The method of claim 10, wherein said selection is based on being able to provide enough resistance to acidic hydroponic nutrients with a dangerous pH level based upon the plant that is being cultivated, or wherein said selection is based on having a high enough tolerance against UV radiation exposure based upon the plant being cultivated.

12. The method of claim 7, wherein the elastic element is configured to dynamically adjust its tension and aperture size in response to the growth of the vegetative root bodies, thereby accommodating varying root system sizes and growth stages without requiring replacement or manual adjustment of the elastic element.
